(19) United States
(12) Patent Application Publication
(10) Pub. No.: US 2026/0210384 A1
(43) Pub. Date: Jul. 23, 2026

(54) Covered Removable Clip

(71) Applicant: Illinois Tool Works Inc., Glenview, IL (US)

(72) Inventors: Kathryn Bailey, Farmington, MI (US); Jason Dobson, Armada, MI (US)

(21) Appl. No.: 19/439,200

(22) Filed: Jan. 2, 2026

Related U.S. Application Data
(60) Provisional application No. 63/747,977, filed on Jan. 22, 2025.

(51) Int. Cl. F16B 2/24

(52) U.S. Cl. CPC F16B 2/243

(57) ABSTRACT

A removable clip for coupling a first component to a second component is disclosed. The clip includes a top plate having a tool opening and a cover formed on the top plate that selectively covers the tool opening. The cover is bendable or removable to permit tool access for clip removal while providing a substantially continuous outer surface when installed. A pair of resilient retention legs extends from the top plate and engages the first and second components to secure the clip in place. Upon bending or removal of the cover, a tool may be inserted through the tool opening to disengage the retention legs and remove the clip. In some examples, the clip is formed as a stamped-metal component and may further include resilient spring arms configured to maintain panel compression and reduce noise, vibration, and rattle between the coupled components.

### RELATED APPLICATION

The present application claims priority to U.S. Provisional Ser. No. 63/747,977, filed Jan. 22, 2025, and entitled “Covered Removable clip,” which is hereby incorporated by reference in its entirety.

### BACKGROUND

Automotive components demand fastening solutions that are not only reliable and efficient but also simple to manufacture and assemble. In many industries, including automotive, aerospace, construction, and consumer electronics, there is a consistent need for fasteners that can securely join two or more panels while allowing for ease of installation, removal, and reuse. Traditional fastening solutions, such as screws, bolts, or rivets, often require specialized tools, threaded components, or permanent deformation of parts, making them less ideal for applications where panels may need to be removed or replaced for maintenance, inspection, or adjustment.

Snap-fit clips and push-in fasteners have become popular alternatives due to their ease of use and cost-effectiveness. However, many existing clip designs face limitations in either retention strength or removability. Some clips offer high retention but are difficult or impossible to remove without damaging the surrounding components. Others prioritize ease of removal but sacrifice the strength of the connection or require access to both sides of the assembly, which may not always be feasible in tightly packaged environments. There is a need for an improved fastener that combines strong panel compression with simple, tool-assisted removal from a single side.

### SUMMARY

The present disclosure relates generally to a fastening system to form a connection between components, substantially as illustrated by and described in connection with at least one of the figures, as set forth more completely in the claims. More particularly, the present disclosure relates generally to a fastening system having a removable clip.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a perspective assembly view of the fastening system with a clip in accordance with aspects of this disclosure.

FIG. 1b illustrates a side assembled view of the fastening system with the clip.

FIG. 2a illustrates an isometric topside view of the clip of FIGS. 1a and 1b.

FIG. 2b illustrates an isometric underside view of the clip.

FIGS. 2c and 2d illustrate, respectively, first and second side elevation views of the clip.

FIGS. 2e and 2f illustrate, respectively, third and fourth side elevation views of the clip.

FIGS. 2g and 2h illustrate, respectively, top and bottom plan views of the clip.

FIG. 3a illustrates an isometric view of a clip.

FIG. 3b illustrates a side elevation cross-sectional view of the clip taken along cut line A-A (FIG. 3a).

FIG. 3c illustrates an isometric cross-sectional view of the clip taken along cut line A-A (FIG. 3a).

FIGS. 4a and 4b illustrate isometric topside and side elevation views of a clip in accordance with another aspect having one or more resilient spring arms.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a removable stamped-metal clip configured to secure a first component (e.g., a panel or trim piece) to a second component (e.g., a support structure or vehicle body panel), while also addressing issues related to unwanted buzz, squeak, and rattle (BSR). The clip is designed for high retention, ease of installation and removal, and reusability.

In one example, a removable clip for coupling a first component to a second component comprises: a top plate that defines a tool opening; a cover formed on the top plate and configured to substantially obstruct or block the tool opening, the cover being selectively bendable or removable to permit access though the tool opening; and a pair of retention legs resiliently coupled to the top plate and oriented to extend away from the top plate, wherein the tool opening is configured to receive a tool, when the cover is bent or removed, to disengage the pair of retention legs from the first component and the second component.

In another example, a stamped-metal clip for coupling a first component to a second component, the stamped-metal clip comprises: a top plate that defines a tool opening; a cover formed on the top plate and configured to selectively block or obstruct the tool opening; and a pair of retention legs resiliently coupled to the top plate and oriented to extend away from the top plate, wherein each of the pair of retention legs comprises a pair of spaced-apart tabs that define engagement surfaces such that a retention zone is formed to accommodate a combined thickness of the first component and the second component, and wherein the tool opening is configured to receive a tool, upon bending or removal of the cover, to disengage the pair of retention legs from the first component and the second component.

In some examples, the removable clip is a stamped-metal clip.

In some examples, the cover includes a free end and an attached end coupled to the top plate by one or more hinge strips.

In some examples, the attached end is coupled to the top plate by a pair of hinge strips with an opening formed therebetween.

In some examples, the cover is configured to be bent away from the top plate while remaining attached to the top plate.

In some examples, the cover is configured to be detached from the top plate.

In some examples, each of the pair of retention legs comprises an engagement surface that defines a retention zone to accommodate a combined thickness of the first component and the second component.

In some examples, each of the pair of retention legs comprises a pair of spaced-apart tabs.

In some examples, at least one of the pair of spaced-apart tabs defines an engagement surface.

In some examples, an edge of the at least one of the pair of spaced-apart tabs defines the engagement surface.

In some examples, each of the pair of retention legs comprises an outer planar portion and an inner planar portion connected by a bend section, and wherein the pair of spaced-apart tabs are coupled to the inner planar portion.

In some examples, the pair of spaced-apart tabs are positioned on opposite sides of the inner planar portion.

In some examples, the pair of spaced-apart tabs are coupled to the inner planar portion at a right angle.

In some examples, the removable clip further comprises one or more resilient spring arms coupled to the top plate and oriented to extend away from the top plate.

In some examples, the one or more resilient spring arms are configured to press against the first component to maintain compression between the first component and the second component.

In some examples, the tool opening is rectangular, circular, or oval.

In some examples, the tool opening is centered on the top plate and positioned between the pair of retention legs.

In some examples, each of the pair of retention legs comprises an outer planar portion and an inner planar portion connected by a bend section, and wherein the pair of spaced-apart tabs are coupled to the inner planar portion.

In some examples, the pair of spaced-apart tabs are positioned on opposite sides of the inner planar portion and coupled to the inner planar portion at a transverse angle.

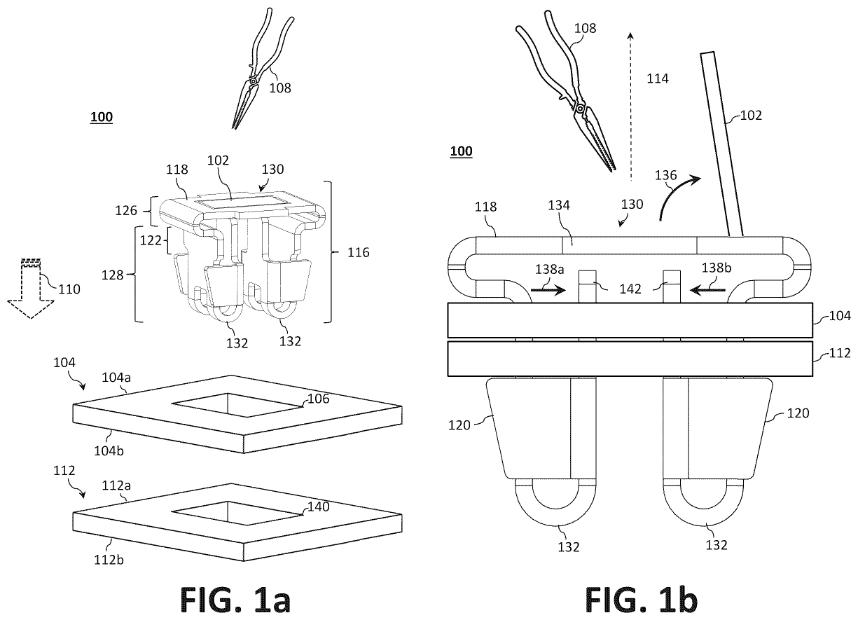

FIGS. 1a and 1b illustrates a perspective assembly and side assembly views of the fastening system 100 with a removable clip 116 in accordance with aspects of this disclosure. The illustrated fastening system 100 generally comprises a removable clip 116 for coupling a first component 104 to a second component 112. The removable clip 116 generally comprises a fastener portion 128 and a head portion 126. As can be appreciated, the removable clip 116 is configured to define a retention zone 122 between or adjacent to the fastener portion 128 and the head portion 126 to engage and securely retain the first component 104 and the second component 112, thereby facilitating a reliable connection between the first component 104 and the second component 112.

The disclosed removable clip 116 offers several advantages over conventional fasteners and clip systems. Initially, the one-piece stamped design of the removable clip 116 minimizes manufacturing complexity and cost. Further, the clip securely retains multiple components, even under dynamic load conditions, to provide high retention. Finally, the removable clip 116 can be disengaged from the top side using a hand tool 108. Accordingly, the robust, reversible design allows the same removable clip 116 to be reused without loss of performance.

In the illustrated example, the first component 104 defines an A-side surface 104a (e.g., a first surface, such as an exterior surface) and a B-side surface 104b (e.g., a second surface, such as an interior surface). The second component 112 similarly defines an A-side surface 112a (e.g., a first surface, such as an exterior surface) and a B-side surface 112b (e.g., a second surface, such as an interior surface). The first component 104 and/or the second component 112 may be, for example, an automotive panel or a structural component of a vehicle, such as doors, pillars (e.g., an A-pillar, B-pillar, C-pillar, etc.), airbag components, dashboard components (e.g., a cross member, bracket, frame, etc.), seat frames, center consoles, fenders, sheet metal framework, or the like. Depending on the application, the first component 104 and/or the second component 112 may be fabricated from metal (or a metal alloy), synthetic or semi-synthetic polymers (e.g., plastics such as acrylonitrile butadiene styrene (ABS) and polyvinyl chloride (PVC)), composite materials (e.g., fiberglass), or a combination thereof.

Each of the first component 104 and the second component 112 includes, defines, or otherwise provides one or more openings (e.g., holes, windows, or cutouts) formed during the manufacturing of the first component 104 and the second component 112, as applicable. The illustrated first component 104 defines a first opening 106, and the illustrated second component 112 defines a second opening 140 that are each configured to, once aligned, receive and retain a portion of the removable clip 116 (e.g., its fastener portion 128). In the illustrated example, the first component 104 provides the first opening 106 as a rectangular window sized to receive a portion of the removable clip 116, while the second component 112 provides the second opening 140 as a rectangular window sized to receive a portion of the removable clip 116. The first opening 106 and the second opening 140 can be substantially the same size and shape, which can be dictated by the dimensions of the fastener portion 128.

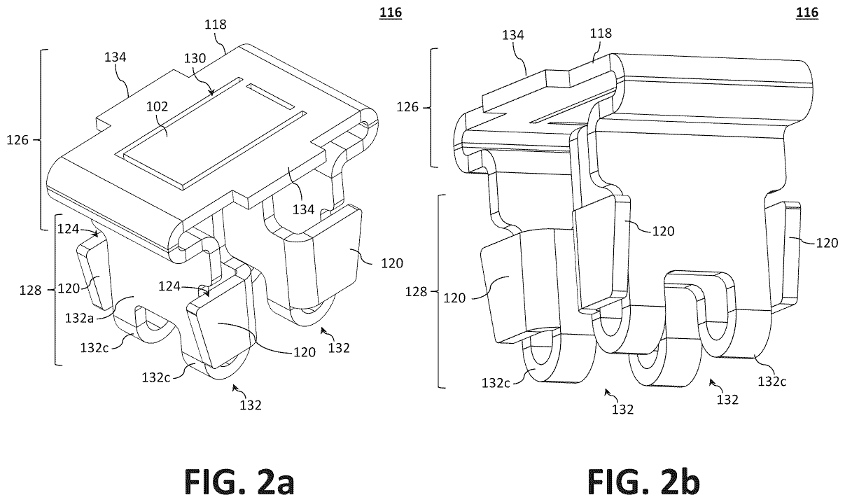

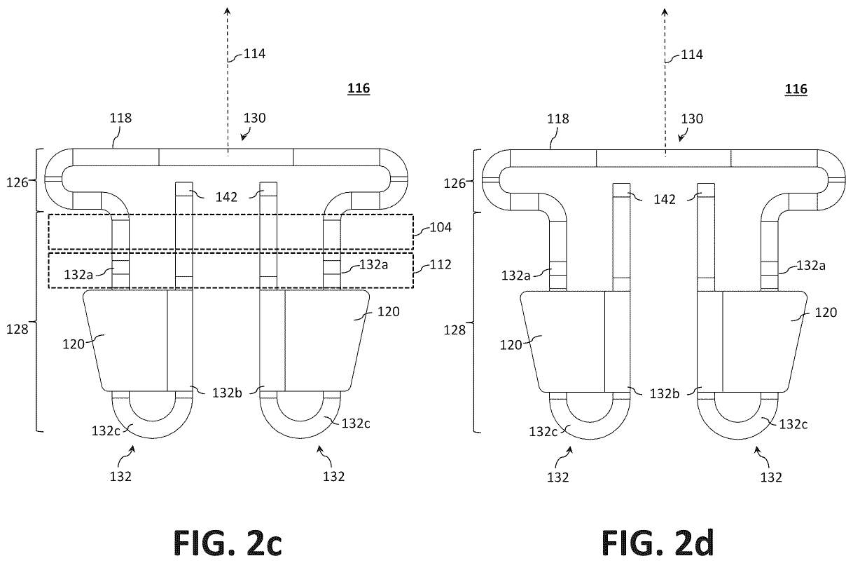

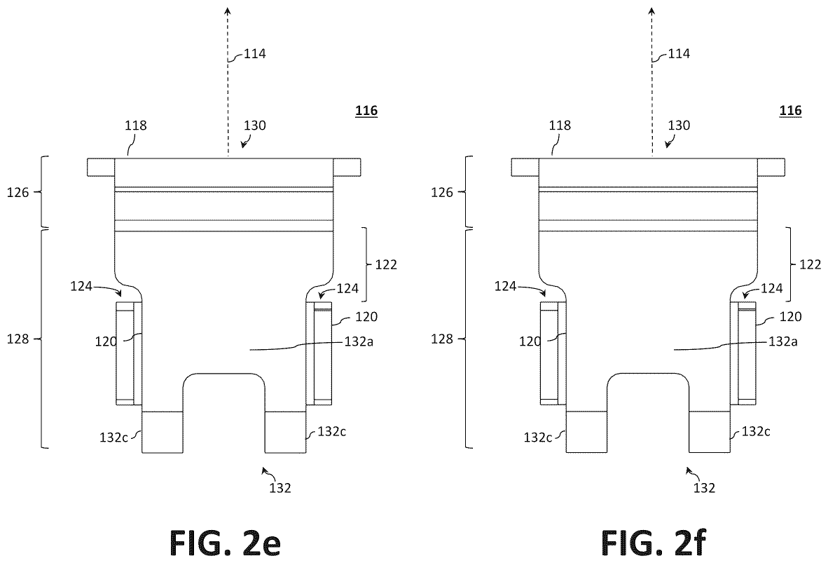

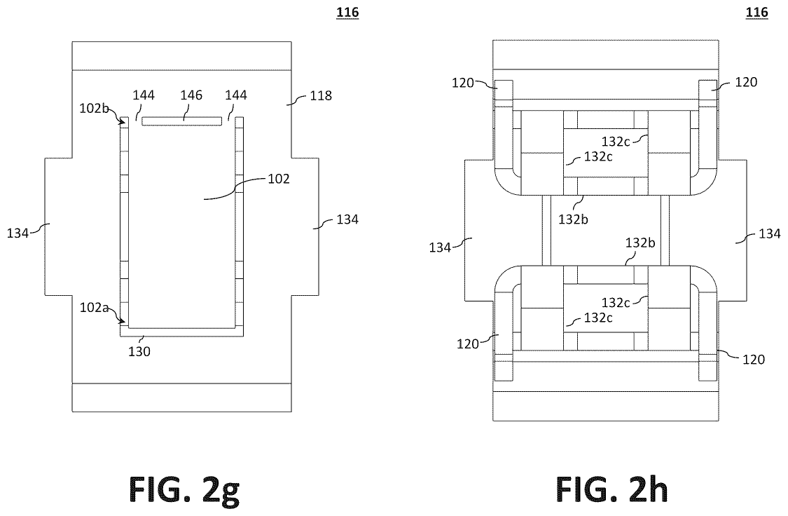

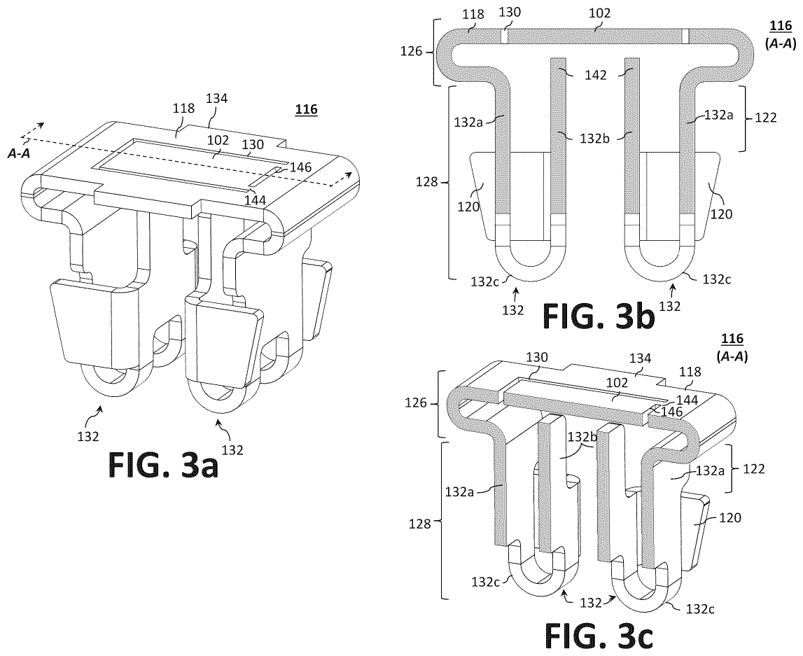

FIG. 2a illustrates an isometric topside view of the removable clip 116 in accordance with an aspect of the disclosure, while FIG. 2b illustrates an isometric underside view of the removable clip 116. FIGS. 2c through 2f illustrate, respectively, first, second, third, and fourth side elevation views of the removable clip 116. Finally, FIGS. 2g and 2h illustrate, respectively, top and bottom plan views of the removable clip 116. FIG. 3a illustrates an isometric view of a removable clip 116, while FIGS. 3b and 3c illustrate, respectively, side elevation and perspective cross-sectional views of the removable clip 116 taken along cut line A-A (FIG. 3a).

The removable clip 116 includes a fastener portion 128 and a head portion 126. The head portion 126 comprises a generally planar top plate 118 that defines a central tool opening 130 and a cover 102 configure to block or obstruct the tool opening 130. The head portion 126 of the removable clip 116 includes the cover 102 formed integrally with the top plate 118 and configured to substantially block or obstruct the tool opening 130. The cover 102 provides a substantially continuous and uniform upper surface of the top plate 118, thereby improving sealing characteristics when the clip 116 is installed. The cover 102 is selectively removable to permit access to release tabs 142 formed on the clip 116, thereby enabling removal of the entire removable clip 116 from the cover-side of the assembly.

The cover 102 includes a free end 102a and an attached end 102b positioned opposite the free end 102a. The attached end 102b is coupled to the top plate 118 of the head portion 126 by a pair of hinge strips 144, with an opening 146 formed therebetween. The opening 146 reduces the amount of material connecting the attached end 102b to the top plate 118, thereby weakening the attachment region and facilitating bending of the cover 102 relative to the top plate 118. In some examples, repeated bending and/or a twisting motion may be applied to the cover 102 to sever the hinge strips 144 and fully detach the cover 102 from the top plate 118, when desired.

With reference to FIG. 1B, the cover 102 may be bent away from the top plate 118 in the direction indicated by arrow 136 to expose a pair of release tabs 142 associated with retention legs 132. In certain examples, the cover 102 can be bent sufficiently to provide tool access to the release tabs 142 while remaining attached to the head portion 126. In other examples, the cover 102 may be fully detached from the top plate 118 using a tool 108.

As illustrated, the tool opening 130 is centered relative to the planar portion of the top plate 118. In other words, the tool opening 130 can be centered between the pair of retention legs 132 to permit access therebetween. The tool opening 130 facilitates tool access for removal using a tool 108. For example, the tool opening 130 allows access to the fastener portion 128 via the head portion 126 when installed, enabling the user to disengage the fastener portion 128 and remove the removable clip 116 from the first component 104 and/or the second component 112. In the illustrated example, the tool opening 130 is rectangular, but other shapes are contemplated, including squares, circles, triangles, ovals, etc.

The illustrated fastener portion 128 includes two retention legs 132 that are resiliently attached to and positioned beneath the head portion 126 (e.g., coupled to the top plate 118). The retention legs 132 extend generally downward from the top plate 118 and are configured to flex relative to the central axis 114 (e.g., toward and away from it) as the fastener portion 128 is inserted through a second opening 140 in the second component 112. In the illustrated example, each retention leg 132 comprises an outer portion 132a (e.g., an outer planar portion 132a) and an inner portion 132b (e.g., an inner planar portion 132b), connected by a bend section 132c (e.g., a U-shaped bend section). Both the outer portion 132a and the inner portion 132b are illustrated as generally planar (e.g., flat), parallel, and spaced to form a gap therebetween. As illustrated, the inner portion 132b comprises, or defines, the release tabs 142 at the free ends there of (e.g., adjacent the tool opening 130 in the head portion 126).

The retention legs 132 are configured to engage the first opening 106 and the second opening 140 (or the edges thereof) formed in the first component 104 and the second component 112 to retain the removable clip 116 in position. In the installed state, the retention legs 132 ensure a high-retention fit, resisting loosening or disengagement due to vibration, thermal cycling, or mechanical stress. The pair of retention legs 132 and the cover 102 are formed integrally with the top plate 118.

The retention legs 132 are inwardly bendable—they flex toward the central longitudinal axis 114 when a portion of a tool 108 (e.g., pliers or the like) is inserted through the top-side tool opening 130. This configuration allows the user to insert the tool 108 from above, apply a squeezing force, and disengage the retention legs 132, thereby facilitating removal of the removable clip 116 without damaging surrounding components. This tool-actuated release mechanism allows the removable clip 116 to be removed and reused, providing advantages in applications requiring frequent disassembly or service access. For example, in automotive interiors or trim assemblies, the ability to remove and reinstall panels without damaging the clip or panel material improves serviceability and reduces replacement part costs.

Each retention leg 132 includes one or more tabs 120 attached to its inner portion 132b. In the illustrated example, each retention leg 132 comprises a pair of spaced-apart tabs 120 on opposite sides of the central axis 114. The pair of spaced-apart tabs 120 are parallel to one another and positioned on opposite sides of the inner portion 132b. With reference to FIGS. 2c and 2d, each of the spaced-apart tabs 120 is generally planar and bent away from the central axis 114 at an angle (e.g., a transverse, non-right angle) relative to the inner portion 132b to define an engagement surface 124. For example, the tabs 120 can be stamped during manufacturing to define a profile where an edge of each tab 120 forms the engagement surface 124. The spaced-apart tabs 120 are, in turn, attached to the outer portion 132 a at a transverse angle (e.g., approximately 90 degrees). The removable clip 116 defines a retention zone 122 between the engagement surface 124 of the spaced-apart tabs 120 and the head portion 126 to accommodate a combined thickness of the first component 104 and the second component 112.

The head portion 126 of the removable clip 116 has a cover 102 formed in the top plate 118 to substantially block or obstruct the tool opening 130. The cover 102 allows a more uniform surface for sealing. With the cover 102 being removable, this allows access for the release tabs 142 on the part so that the entire part is removable from the cover 102 side.

The cover 102 includes a free end 102a and an attached end 102b that is opposite the free end 102a. The attached end 102b is coupled to the top plate 118 of the head portion 126 via a pair of hinge strips 144, with an opening 146 positioned therebetween. The opening 146 serves to weaken the attachment between the attached end 102b and the top plate 118 by limiting the amount of material therebetween. Thus allowing the cover 102 to be more easily bent relative to the top plate 118 or, where desired, removed from the top plate 118 (e.g., by repeating bending and/or a twist motion to sever the pair of hinge strips 144)

With reference to FIG. 1b, the cover 102 can be bent back as indicated by arrow 136 to reveal a pair of release tabs 142 associated with the retention legs 132. In some examples, the cover 102 that can be bent back sufficiently in the direction of arrow 136 to provide access to the pair of release tabs 142 via the tool 108, while remaining attached to the head portion 126. The cover 102 can also be detached from the top plate 118 via the tool 108. The release tabs 142 are elongated to have a tool Inserted in the cover 102 of the part and then pull back the pair of release tabs 142 associated with the retention legs 132 to remove the removable clip 116.

The release tabs 142 can be manipulated via a tool 108 to easily remove the entire removable clip 116 from the first component 104 and/or second component 112. For example, the pair of release tabs 142 can be compressed toward anther another (e.g., toward the central axis 114 as indicated by arrows 138a, 138b. compressing the pair of release tabs 142 (e.g., squeezing or pinching them via the tool 108, such as a pair of pliers), causes the pair of spaced-apart tabs 120 to flex inwardly toward the center axis 114, thus clearing and disengaging the first opening 106 and the second opening 140. In some examples, the removable clip 116 is not reusable as the cover 102 cannot be bent back fully into its original position.

In some examples, engagement tabs 134 form on and extending on the sides of the top plate 118 can be used to facilitate automated installation. For example, the engagement tabs 134 can be used to facilitate attachment with an automated system, such as a robot.

The components of the removable clip 116 may be formed as a unitary structure. The removable clip 116 may be fabricated as a single component using a metal stamping process. For example, the clip 116 can be stamped from a sheet of metal using a die-stamping process to define the geometry of various features, and then bent to assume the final shape via one or more bending steps. That is, the sheet of metal can be stamped and bent to define, inter alia, the retention legs 132 (and engagement surfaces 124), cover 102, tool opening 130, etc.

In another example, the removable clip 116 can be fabricated from plastic using mold tooling and a plastic injection molding process. Alternatively, the clip 116 can be a printed thermoplastic component produced via additive manufacturing, allowing high accuracy and detail—particularly advantageous for components requiring complex or precise features. Additive manufacturing techniques eliminate the need for mold tooling typically associated with injection molding, reducing up-front manufacturing costs, which is especially beneficial for low-volume production. In some examples, the removable clip 116 may be fabricated using material extrusion (e.g., fused deposition modeling (FDM)), stereolithography (SLA), selective laser sintering (SLS), material jetting, binder jetting, powder bed fusion, directed energy deposition, vat photopolymerization, or any other suitable 3D printing process.

FIG. 2c illustrates a side elevation view of the removable clip 116 coupled with the first component 104 and second component 112 to demonstrate the retention zone 122. That is, the pair of retention legs 132 defines the retention zone 122 between the engagement surface 124 and the head portion 126 to accommodate a combined thickness of the first component 104 and second component 112.

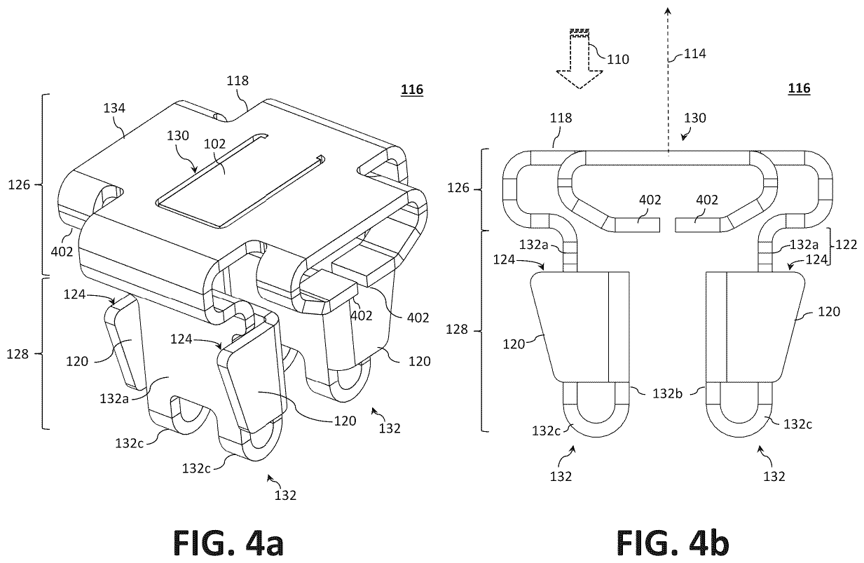

FIGS. 4A and 4B illustrate isometric top-side and side elevation views, respectively, of a clip 116 according to another aspect, wherein the clip 116 includes one or more resilient spring arms 402. The clip 116 shown in FIGS. 4A and 4B is structurally the same as the clip described with reference to FIGS. 2A-2F, except for the addition of the resilient spring arms 402. Further, while the attached end 102b is illustrated with a solid, continuation connection, a pair of hinge strips 144 with an opening 146 formed therebetween can be used.

The spring arms 402 are coupled to the clip 116, for example, to the top plate 118 at or adjacent to the engagement tabs 134. In the illustrated example, the clip 116 includes two pairs of resilient spring arms 402. The spring arms 402 extend downwardly from the top plate 118 and are resiliently biased toward an A-side surface 104a of the first component 104.

When the removable clip 116 is installed onto the first component 104 and the second component 112, as indicated by arrow 110, the spring arms 402 bear against the first component 104 and generate a spring force that maintains consistent panel compression between the components. This spring force reduces or eliminates gaps between the components that could otherwise result in buzz, squeak, and rattle (BSR) noise.

Additionally, the resilient spring arms 402 maintain continuous contact with the first component 104 during use, thereby dampening vibrations and further minimizing relative movement between the components that may contribute to BSR conditions.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A removable clip for coupling a first component to a second component, the removable clip comprising:
a top plate that defines a tool opening;
a cover formed on the top plate and configured to substantially obstruct or block the tool opening, the cover being selectively bendable or removable to permit access though the tool opening; and
a pair of retention legs resiliently coupled to the top plate and oriented to extend away from the top plate,
wherein the tool opening is configured to receive a tool, when the cover is bent or removed, to disengage the pair of retention legs from the first component and the second component.

2. The removable clip of claim 1, wherein the removable clip is a stamped-metal clip.

3. The removable clip of claim 1, wherein the cover includes a free end and an attached end coupled to the top plate by one or more hinge strips.

4. The removable clip of claim 3, wherein the attached end is coupled to the top plate by a pair of hinge strips with an opening formed therebetween.

5. The removable clip of claim 1, wherein the cover is configured to be bent away from the top plate while remaining attached to the top plate.

6. The removable clip of claim 1, wherein the cover is configured to be detached from the top plate.

7. The removable clip of claim 1, wherein each of the pair of retention legs comprises an engagement surface that defines a retention zone to accommodate a combined thickness of the first component and the second component.

8. The removable clip of claim 1, wherein each of the pair of retention legs comprises a pair of spaced-apart tabs.

9. The removable clip of claim 8, wherein at least one of the pair of spaced-apart tabs defines an engagement surface.

10. The removable clip of claim 9, wherein an edge of the at least one of the pair of spaced-apart tabs defines the engagement surface.

11. The removable clip of claim 8, wherein each of the pair of retention legs comprises an outer planar portion and an inner planar portion connected by a bend section, and wherein the pair of spaced-apart tabs are coupled to the inner planar portion.

12. The removable clip of claim 11, wherein the pair of spaced-apart tabs are positioned on opposite sides of the inner planar portion.

13. The removable clip of claim 11, wherein the pair of spaced-apart tabs are coupled to the inner planar portion at a right angle.

14. The removable clip of claim 1, further comprising one or more resilient spring arms coupled to the top plate and oriented to extend away from the top plate.

15. The removable clip of claim 14, wherein the one or more resilient spring arms are configured to press against the first component to maintain compression between the first component and the second component.

16. The removable clip of claim 1, wherein the tool opening is rectangular, circular, or oval.

17. The removable clip of claim 1, wherein the tool opening is centered on the top plate and positioned between the pair of retention legs.

18. A stamped-metal clip for coupling a first component to a second component, the stamped-metal clip comprising:
a top plate that defines a tool opening;
a cover formed on the top plate and configured to selectively block or obstruct the tool opening; and
a pair of retention legs resiliently coupled to the top plate and oriented to extend away from the top plate,
wherein each of the pair of retention legs comprises a pair of spaced-apart tabs that define engagement surfaces such that a retention zone is formed to accommodate a combined thickness of the first component and the second component, and
wherein the tool opening is configured to receive a tool, upon bending or removal of the cover, to disengage the pair of retention legs from the first component and the second component.

19. The stamped-metal clip of claim 18, wherein each of the pair of retention legs comprises an outer planar portion and an inner planar portion connected by a bend section, and wherein the pair of spaced-apart tabs are coupled to the inner planar portion.

20. The stamped-metal clip of claim 19, wherein the pair of spaced-apart tabs are positioned on opposite sides of the inner planar portion and coupled to the inner planar portion at a transverse angle.
